(19) United States
(12) Patent Application Publication
(10) Pub. No.: US 2024/0243591 A1
(43) Pub. Date: Jul. 18, 2024

(54) POWER SUPPLY CONTROL APPARATUS AND POWER SUPPLY APPARATUS

(71) Applicant: MURATA MANUFACTURING CO., LTD., Kyoto (JP)

(72) Inventor: Jusuke SHIMURA, Kyoto (JP)

(21) Appl. No.: 18/427,422

(22) Filed: Jan. 30, 2024

Related U.S. Application Data
(63) Continuation of application No. PCT/JP2022/030771, filed on Aug. 12, 2022.

(30) Foreign Application Priority Data
Aug. 31, 2021 (JP) 2021-141993

(51) Int. Cl. H02J 7/00

(52) U.S. Cl. CPC H02J 7/0024; H02J 7/0031; H02J 7/0047

(57) ABSTRACT

A power supply control apparatus according to an embodiment of the present technology includes a controller and sensors. The controller controls discharging of secondary battery units coupled in parallel to each other. The sensors are assigned to the secondary batteries on a one-to-one basis. The sensors each detect a current flowing through a current path of corresponding one of the secondary batteries or a physical quantity having a predetermined correlation with the current. The controller switches coupling between a first secondary battery and each of one or more second secondary batteries from parallel coupling to series coupling by controlling a switching unit based on a detection result obtained from each of the sensors. The first secondary battery is any one of the secondary batteries. The one or more second secondary batteries are one or more of the secondary batteries other than the first secondary battery.

### CROSS REFERENCE TO RELATED APPLICATIONS

The present application is a continuation of PCT patent application no. PCT/JP2022/030771, filed on Aug. 12, 2022, which claims priority to Japanese patent application no. 2021-141993, filed on Aug. 31, 2021, the entire contents of which are incorporated herein by reference.

### BACKGROUND

The present application relates to a power supply control apparatus and a power supply apparatus.

In recent years, for example, electric automobiles and hybrid automobiles have been widely used. In addition, power generation devices using, for example, photovoltaic power generation and wind power generation that are unstable in generated power and require leveling of the power have also been widely used. The widespread use of such automobiles and such power generation devices has led to a rapid rise in demand of various secondary batteries including, without limitation, lithium-ion secondary batteries.

In a secondary battery, for example, when an internal short circuit is caused by a foreign object (e.g., a nail or a metal piece) penetrating the secondary battery from an outside, Joule heat is generated around a short-circuited part. Depending on a generation state of the Joule heat, thermal runaway can occur in the secondary battery. Such an internal short circuit in the secondary battery due to a foreign object can occur, for example, upon a crash accident of a mobile body in a case of the secondary battery mounted on the mobile body, or when the foreign object falls on the secondary battery due to a disaster such as an earthquake. An internal short circuit can also be caused by a dendrite.

Existing techniques of reducing a risk of ignition caused by an internal short circuit have been proposed. For example, two or more secondary batteries are disposed in parallel, and a secondary battery in which an internal short circuit has occurred is subjected to emergency discharge by means of a maximum power point tracking (MPPT) circuit to be maximized in output power. Further, for example, a secondary battery in which an internal short circuit has occurred is subjected to emergency discharge by being coupled in series to another secondary battery in which no internal short circuit has occurred, by means of a closed circuit.

### SUMMARY

The present application relates to a power supply control apparatus and a power supply apparatus.

Emergency discharge is a way of control that itself involves a risk. Therefore, to allow for automatic emergency discharge, an internal short circuit is to be detected accurately. It is therefore desirable to provide a power supply control apparatus and a power supply apparatus that each make it possible to accurately detect an internal short circuit.

A power supply control apparatus according to an embodiment of the present technology includes a controller and sensors. The controller controls discharging of secondary battery units coupled in parallel to each other. The secondary battery units each include secondary batteries and a switching unit. The switching unit switches coupling of the secondary batteries. The sensors are assigned to the secondary batteries on a one-to-one basis. The sensors each detect a current flowing through a current path of corresponding one of the secondary batteries or a physical quantity having a predetermined correlation with the current. The controller switches coupling between a first secondary battery and each of one or more second secondary batteries from parallel coupling to series coupling by controlling the switching unit based on a detection result obtained from each of the sensors. The first secondary battery is any one of the secondary batteries. The one or more second secondary batteries are one or more of the secondary batteries other than the first secondary battery.

A power supply apparatus according to an embodiment of the present technology includes secondary battery units and a controller. The secondary battery units are coupled in parallel to each other. The controller controls discharging of the secondary battery units. The secondary battery units each include secondary batteries, a switching unit, and sensors. The switching unit switches coupling of the secondary batteries. The sensors are assigned to the secondary batteries on a one-to-one basis. The sensors each detect a current flowing through a current path of corresponding one of the secondary batteries or a physical quantity having a predetermined correlation with the current. The controller switches coupling between a first secondary battery and each of one or more second secondary batteries from parallel coupling to series coupling by controlling the switching unit based on a detection result obtained from each of the sensors. The first secondary battery is any one of the secondary batteries. The one or more second secondary batteries are one or more of the secondary batteries other than the first secondary battery.

According to an embodiment, the sensors each detect the current flowing through the current path of corresponding one of the secondary batteries or the physical quantity having the predetermined correlation with the current. This makes it possible to accurately detect an internal short circuit.

Note that effects of the present technology are not necessarily limited to those described herein and may include any suitable effect, including described below, in relation to the present technology.

### BRIEF DESCRIPTION OF THE FIGURES

FIG. 1 is a diagram illustrating an example of a circuit configuration of a power supply apparatus according to an embodiment of the present technology.

FIG. 2 is a diagram illustrating a modification of the circuit configuration of the power supply apparatus illustrated in FIG. 1.

FIG. 3 is a diagram illustrating an example of an emergency discharge procedure for the power supply apparatus illustrated in FIG. 1.

FIG. 4 is a diagram illustrating a state of normal discharge in the power supply apparatus illustrated in FIG. 1.

FIG. 5 is a simplified diagram illustrating the state of the normal discharge.

FIG. 6 is a diagram illustrating a state where a short circuit has occurred in the power supply apparatus illustrated in FIG. 1.

FIG. 7 is a diagram illustrating a state of partial series coupling in the power supply apparatus illustrated in FIG. 1.

FIG. 8 is a simplified diagram illustrating the state of the partial series coupling.

FIG. 9 is a diagram illustrating a state in which a part where a short circuit has occurred is isolated in the power supply apparatus illustrated in FIG. 1.

FIG. 10 is a simplified diagram illustrating the state in which the part where the short circuit has occurred is isolated.

FIG. 11 is a diagram illustrating an example of changes over time in respective voltages of secondary batteries and in amount of heat generated in a short-circuited secondary battery, when a short circuit has occurred in the power supply apparatus illustrated in FIG. 1.

FIG. 12 is a diagram illustrating an example of the changes over time in the respective voltages of the secondary batteries and in the amount of heat generated in the short-circuited secondary battery, when the short circuit has occurred in the power supply apparatus illustrated in FIG. 1.

FIG. 13 is a simplified diagram illustrating a state in which a short circuit has occurred in a power supply apparatus according to a comparative example.

FIG. 14 is a diagram illustrating an example of changes over time in respective voltages of secondary batteries and in amount of heat generated in a short-circuited secondary battery, when a short circuit has occurred in the power supply apparatus illustrated in FIG. 13.

FIG. 15 is a diagram illustrating an example of the changes over time in the respective voltages of the secondary batteries and in the amount of heat generated in the short-circuited secondary battery, when the short circuit has occurred in the power supply apparatus illustrated in FIG. 13.

FIG. 16 is a diagram illustrating an example of a circuit configuration of a sensor illustrated in FIG. 1.

FIG. 17 is a diagram for describing respective thresholds of comparators illustrated in FIG. 16.

FIG. 18 is a diagram illustrating an example of a functional block of a controller illustrated in FIG. 1.

FIG. 19 is a diagram illustrating an example of a circuit configuration of a CPLD illustrated in FIG. 18.

FIG. 20 is a diagram illustrating an example of input and output combinations (a truth table) of an encoder illustrated in FIG. 19.

FIG. 21 is a diagram illustrating an example of the input and output combinations (the truth table) of the encoder illustrated in FIG. 19.

FIG. 22 is a diagram illustrating an example of state transition of a STATE pin illustrated in FIG. 19.

FIG. 23 is a diagram illustrating an example of input and output combinations (a truth table) of a decoder illustrated in FIG. 19.

FIG. 24 is a diagram illustrating an example of the input and output combinations (the truth table) of the decoder illustrated in FIG. 19.

FIG. 25 is a diagram illustrating an example of the input and output combinations (the truth table) of the decoder illustrated in FIG. 19.

FIG. 26 is a diagram illustrating an example of the input and output combinations (the truth table) of the decoder illustrated in FIG. 19.

FIG. 27 is a diagram illustrating an example of the input and output combinations (the truth table) of the decoder illustrated in FIG. 19.

FIG. 28 is a diagram illustrating an example of the input and output combinations (the truth table) of the decoder illustrated in FIG. 19.

FIG. 29 is a diagram illustrating an example of an operation of sensors illustrated in FIG. 19.

### DETAILED DESCRIPTION

The present technology will be described below in further detail including with reference to the drawings according to an embodiment.

First, a description is given of a secondary battery to be used in a power supply apparatus according to an embodiment of the present technology.

The secondary battery to be used in the present technology may include, for example, a secondary battery of more than about several hundred milliampere-hours, which involves a risk of actual smoke generation and actual ignition upon occurrence of an internal short circuit. Examples of the secondary battery of more than about several hundred milliampere-hours include a battery of a laminated type or a cylindrical type. The secondary battery to be used in the present technology is not particularly limited in charge and discharge principle. For example, the secondary battery to be used in the present technology is configured to obtain a battery capacity using insertion and extraction of an electrode reactant. The secondary battery to be used in the present technology includes, for example, a positive electrode, a negative electrode, and an electrolyte. In the secondary battery to be used in the present technology, for example, to prevent precipitation of the electrode reactant on a surface of the negative electrode during charging, a charge capacity of the negative electrode is greater than a discharge capacity of the positive electrode. In this case, an electrochemical capacity per unit area of the negative electrode is set to be, for example, greater than an electrochemical capacity per unit area of the positive electrode.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium. A secondary battery that obtains a battery capacity using insertion and extraction of lithium is what is called a lithium-ion secondary battery. In the lithium-ion secondary battery, lithium is inserted and extracted in an ionic state.

Next, an issue of the secondary battery to be used in the present technology will be described.

In the secondary battery to be used in the present technology, for example, when a short circuit between the positive electrode and the negative electrode (hereinafter, referred to as an “internal short circuit”) is caused by a foreign object (e.g., a nail or a metal piece) penetrating the secondary battery from an outside, Joule heat is generated around a short-circuited part. Depending on a generation state of the Joule heat, thermal runaway can occur in the secondary battery. Such an internal short circuit in the secondary battery due to a foreign object can occur, for example, upon a crash accident of a mobile body in a case of the secondary battery mounted on the mobile body, or when the foreign object falls on the secondary battery due to a disaster such as an earthquake. An internal short circuit can also be caused by a dendrite.

When local heat generation occurs due to an internal short circuit, there is a very short time until the temperature of a material included in the secondary battery exceeds, for example, a thermal decomposition temperature or an ignition temperature of the material. The most effective way to help to prevent ignition that is to start within a very short time is to suppress the Joule heat generated at the part where the internal short circuit has occurred. A way to achieve such suppression of the Joule heat is to subject the secondary battery in which the internal short circuit has occurred to emergency discharge immediately after detection of the internal short circuit, and to suppress a current flowing into the secondary battery in which the internal short circuit has occurred.

Existing techniques of reducing a risk of ignition caused by an internal short circuit have been proposed, for example, in PTL 1: International Publication No. WO2018/186496 and PTL 2: Japanese Unexamined Patent Application Publication No. 2008-289296. In PTL 1, for example, two or more secondary batteries are disposed in parallel, and a secondary battery in which an internal short circuit has occurred is subjected to emergency discharge by means of a maximum power point tracking (MPPT) circuit to be maximized in output power. In PTL 2, for example, a secondary battery in which an internal short circuit has occurred is subjected to emergency discharge by being coupled in series to another secondary battery in which no internal short circuit has occurred, by means of a closed circuit.

However, the method disclosed in PTL 1 makes it difficult to reduce the size of the MPPT circuit, and increases cost. The method disclosed in PTL 2 interrupts power supply to electronic equipment upon the emergency discharge, and is therefore unsuitable for an application in which loss of power is unacceptable even for an instant. To address this, the inventor of the present application proposes, for example, a power supply apparatus that does not interrupt power supply upon emergency discharge and is easily reducible in size.

Next, a configuration of a power supply apparatus 100 according to an embodiment of the present technology will be described.

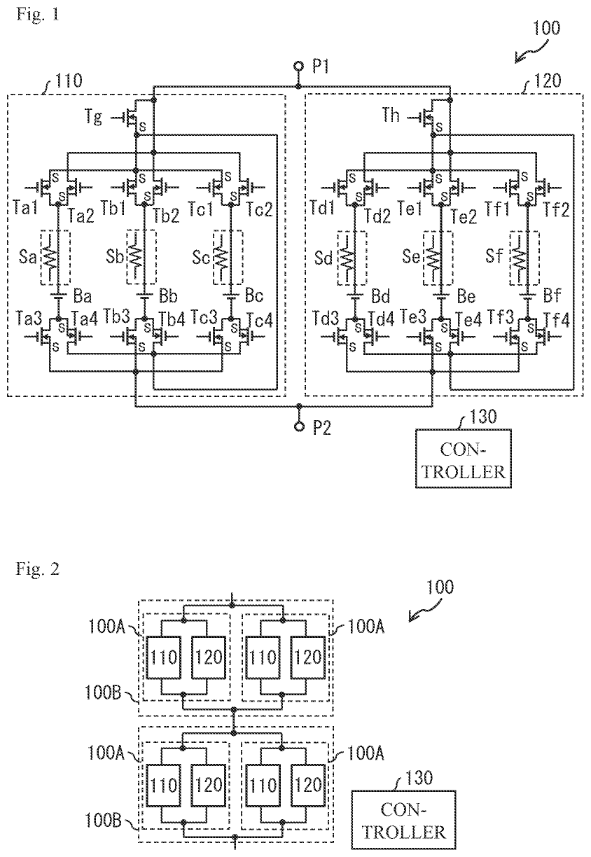

FIG. 1 illustrates an example of a circuit configuration of the power supply apparatus 100 according to an embodiment. As illustrated in FIG. 1, the power supply apparatus 100 includes, for example, two secondary battery units 110 and 120 coupled in parallel to each other. When the two secondary battery units 110 and 120 coupled in parallel to each other are regarded as a secondary battery module 100A, the power supply apparatus 100 may include, for example, two secondary battery modules 100A coupled in parallel to each other, as illustrated in FIG. 2. When the two secondary battery modules 100A coupled in parallel to each other are regarded as a secondary battery module 100B, the power supply apparatus 100 may include, for example, two secondary battery modules 100B coupled in series to each other, as illustrated in FIG. 2.

In the power supply apparatus 100, the number of the secondary battery units coupled in parallel to each other is not limited to two, and may be three or more. In the power supply apparatus 100, the number of the secondary battery modules 100A coupled in parallel to each other is not limited to two, and may be three or more. In the power supply apparatus 100, the number of the secondary battery modules 100A coupled in series to each other is not limited to two either, and may be three or more.

As illustrated in FIG. 1, the power supply apparatus 100 further includes, for example, a controller 130 that controls discharging of the two secondary battery units 110 and 120. The controller 130 includes, for example, a central processing unit (CPU) that executes a predetermined calculation process, a read-only memory (ROM) in which a predetermined control program is stored, and a random-access memory (RAM) in which data is to be temporarily stored. The controller 130 controls the discharging of the two secondary battery units 110 and 120, for example, by executing the control program stored in the ROM.

The secondary battery unit 110 includes, for example, three secondary batteries Ba, Bb, and Bc and three sensors Sa, Sb, and Sc. The sensor Sa is coupled in series to the secondary battery Ba, or is installed in the vicinity of a wiring line coupled to a positive electrode or a negative electrode of the secondary battery Ba. The sensor Sb is coupled in series to the secondary battery Bb, or is installed in the vicinity of a wiring line coupled to a positive electrode or a negative electrode of the secondary battery Bb. The sensor Sc is coupled in series to the secondary battery Bc, or is installed in the vicinity of a wiring line coupled to a positive electrode or a negative electrode of the secondary battery Bc.

The secondary battery unit 110 further includes, for example, four field-effect transistors (FETs) Ta1, Ta2, Ta3, and Ta4 each coupled in series to the secondary battery Ba. The secondary battery unit 110 further includes, for example, four field-effect transistors (FETs) Tb1, Tb2, Tb3, and Tb4 each coupled in series to the secondary battery Bb. The secondary battery unit 110 further includes, for example, four field-effect transistors (FETs) Tc1, Tc2, Tc3, and Tc4 each coupled in series to the secondary battery Bc. Note that in the secondary battery unit 110, the number of secondary batteries is not limited to three, and may be two, or may be four or more.

The field-effect transistors Ta1 and Ta2 are provided on a positive electrode side of the secondary battery Ba. The field-effect transistors Ta3 and Ta4 are provided on a negative electrode side of the secondary battery Ba. A drain of the field-effect transistor Ta1 and a source of the field-effect transistor Ta2 are coupled to each other. A coupling point of the drain of the field-effect transistor Ta1 and the source of the field-effect transistor Ta2 is coupled to the positive electrode of the secondary battery Ba directly or via the sensor Sa. A drain of the field-effect transistor Ta3 and a source of the field-effect transistor Ta4 are coupled to each other. A coupling point of the drain of the field-effect transistor Ta3 and the source of the field-effect transistor Ta4 is coupled to the negative electrode of the secondary battery Ba directly or via the sensor Sa.

The field-effect transistors Tb1 and Tb2 are provided on a positive electrode side of the secondary battery Bb. The field-effect transistors Tb3 and Tb4 are provided on a negative electrode side of the secondary battery Bb. A drain of the field-effect transistor Tb1 and a source of the field-effect transistor Tb2 are coupled to each other. A coupling point of the drain of the field-effect transistor Tb1 and the source of the field-effect transistor Tb2 is coupled to the positive electrode of the secondary battery Bb directly or via the sensor Sb. A drain of the field-effect transistor Tb3 and a source of the field-effect transistor Tb4 are coupled to each other. A coupling point of the drain of the field-effect transistor Tb3 and the source of the field-effect transistor Tb4 is coupled to the negative electrode of the secondary battery Bb directly or via the sensor Sb.

The field-effect transistors Tc1 and Tc2 are provided on a positive electrode side of the secondary battery Bc. The field-effect transistors Tc3 and Tc4 are provided on a negative electrode side of the secondary battery Bc. A drain of the field-effect transistor Tc1 and a source of the field-effect transistor Tc2 are coupled to each other. A coupling point of the drain of the field-effect transistor Tc1 and the source of the field-effect transistor Tc2 is coupled to the positive electrode of the secondary battery Bc directly or via the sensor Sc. A drain of the field-effect transistor Tc3 and a source of the field-effect transistor Tc4 are coupled to each other. A coupling point of the drain of the field-effect transistor Tc3 and the source of the field-effect transistor Tc4 is coupled to the negative electrode of the secondary battery Bc directly or via the sensor Sc.

The secondary battery unit 110 further includes, for example, one field-effect transistor Tg. A source of the field-effect transistor Tg is coupled to respective sources of the field-effect transistors Ta1, Tb1, and Tc1 and to respective drains of the field-effect transistors Ta4, Tb4, and Tc4. A drain of the field-effect transistor Tg is coupled to respective drains of the field-effect transistors Ta2, Tb2, and Tc2 and to a positive electrode terminal P1 of the power supply apparatus 100. The respective sources of the field-effect transistors Ta2, Tb2, and Tc2 are coupled to a negative electrode terminal P2 of the power supply apparatus 100.

The secondary battery unit 120 includes, for example, three secondary batteries Bd, Be, and Bf and three sensors Sd, Se, and Sf. The sensor Sd is coupled in series to the secondary battery Bd, or is installed in the vicinity of a wiring line coupled to a positive electrode or a negative electrode of the secondary battery Bd. The sensor Se is coupled in series to the secondary battery Be, or is installed in the vicinity of a wiring line coupled to a positive electrode or a negative electrode of the secondary battery Be. The sensor Sf is coupled in series to the secondary battery Bf, or is installed in the vicinity of a wiring line coupled to a positive electrode or a negative electrode of the secondary battery Bf.

The secondary battery unit 120 further includes, for example, four field-effect transistors (FETs) Td1, Td2, Td3, and Td4 each coupled in series to the secondary battery Bd. The secondary battery unit 120 further includes, for example, four field-effect transistors (FETs) Te1, Te2, Te3, and Te4 each coupled in series to the secondary battery Be. The secondary battery unit 120 further includes, for example, four field-effect transistors (FETs) Tf1, Tf2, Tf3, and Tf4 each coupled in series to the secondary battery Bf. Note that in the secondary battery unit 120, the number of secondary batteries is not limited to three, and may be two, or may be four or more.

The field-effect transistors Td1 and Td2 are provided on a positive electrode side of the secondary battery Bd. The field-effect transistors Td3 and Td4 are provided on a negative electrode side of the secondary battery Bd. A drain of the field-effect transistor Td1 and a source of the field-effect transistor Td2 are coupled to each other. A coupling point of the drain of the field-effect transistor Td1 and the source of the field-effect transistor Td2 is coupled to the positive electrode of the secondary battery Bd directly or via the sensor Sd. A drain of the field-effect transistor Td3 and a source of the field-effect transistor Td4 are coupled to each other. A coupling point of the drain of the field-effect transistor Td3 and the source of the field-effect transistor Td4 is coupled to the negative electrode of the secondary battery Bd directly or via the sensor Sd.

The field-effect transistors Te1 and Te2 are provided on a positive electrode side of the secondary battery Be. The field-effect transistors Te3 and Te4 are provided on a negative electrode side of the secondary battery Be. A drain of the field-effect transistor Te1 and a source of the field-effect transistor Te2 are coupled to each other. A coupling point of the drain of the field-effect transistor Te1 and the source of the field-effect transistor Te2 is coupled to the positive electrode of the secondary battery Be directly or via the sensor Se. A drain of the field-effect transistor Te3 and a source of the field-effect transistor Te4 are coupled to each other. A coupling point of the drain of the field-effect transistor Te3 and the source of the field-effect transistor Te4 is coupled to the negative electrode of the secondary battery Be directly or via the sensor Se.

The field-effect transistors Tf1 and Tf2 are provided on a positive electrode side of the secondary battery Bf. The field-effect transistors Tf3 and Tf4 are provided on a negative electrode side of the secondary battery Bf. A drain of the field-effect transistor Tf1 and a source of the field-effect transistor Tf2 are coupled to each other. A coupling point of the drain of the field-effect transistor Tf1 and the source of the field-effect transistor Tf2 is coupled to the positive electrode of the secondary battery Bf directly or via the sensor Sf. A drain of the field-effect transistor Tf3 and a source of the field-effect transistor Tf4 are coupled to each other. A coupling point of the drain of the field-effect transistor Tf3 and the source of the field-effect transistor Tf4 is coupled to the negative electrode of the secondary battery Bf directly or via the sensor Sf.

The secondary battery unit 120 further includes, for example, one field-effect transistor Th. A source of the field-effect transistor Th is coupled to respective sources of the field-effect transistors Td1, Te1, and Tf1 and to respective drains of the field-effect transistors Td4, Te4, and Tf4. A drain of the field-effect transistor Th is coupled to respective drains of the field-effect transistors Td2, Te2, and Tf2 and to the positive electrode terminal P1 of the power supply apparatus 100. The respective sources of the field-effect transistors Td2, Te2, and Tf2 are coupled to the negative electrode terminal P2 of the power supply apparatus 100.

The sensor Sa is a sensor that detects a physical quantity serving as a clue for detecting an internal short circuit in the secondary battery Ba, and supplies a signal indicating the physical quantity to the controller 130. The sensor Sa is, for example, an ammeter that detects a current flowing through a shunt resistor coupled in series to the secondary battery Ba. The sensor Sa may be configured to detect, for example, a physical quantity having a predetermined correlation with the current flowing through the shunt resistor described above. The sensor Sa may be, for example, a voltmeter that detects a voltage of the shunt resistor described above, or a magnetometer that detects a magnetic field generated by the wiring line coupled to the positive electrode or the negative electrode of the secondary battery Ba.

The sensor Sb is a sensor that detects a physical quantity serving as a clue for detecting an internal short circuit in the secondary battery Bb, and supplies a signal indicating the physical quantity to the controller 130. The sensor Sb is, for example, an ammeter that detects a current flowing through a shunt resistor coupled in series to the secondary battery Bb. The sensor Sb may be configured to detect, for example, a physical quantity having a predetermined correlation with the current flowing through the shunt resistor described above. The sensor Sb may be, for example, a voltmeter that detects a voltage of the shunt resistor described above, or a magnetometer that detects a magnetic field generated by the wiring line coupled to the positive electrode or the negative electrode of the secondary battery Bb.

The sensor Sc is a sensor that detects a physical quantity serving as a clue for detecting an internal short circuit in the secondary battery Bc, and supplies a signal indicating the physical quantity to the controller 130. The sensor Sc is, for example, an ammeter that detects a current flowing through a shunt resistor coupled in series to the secondary battery Bc. The sensor Sc may be configured to detect, for example, a physical quantity having a predetermined correlation with the current flowing through the shunt resistor described above. The sensor Sc may be, for example, a voltmeter that detects a voltage of the shunt resistor described above, or a magnetometer that detects a magnetic field generated by the wiring line coupled to the positive electrode or the negative electrode of the secondary battery Bc.

The sensor Sd is a sensor that detects a physical quantity serving as a clue for detecting an internal short circuit in the secondary battery Bd, and supplies a signal indicating the physical quantity to the controller 130. The sensor Sd is, for example, an ammeter that detects a current flowing through a shunt resistor coupled in series to the secondary battery Bd. The sensor Sd may be configured to detect, for example, a physical quantity having a predetermined correlation with the current flowing through the shunt resistor described above. The sensor Sd may be, for example, a voltmeter that detects a voltage of the shunt resistor described above, or a magnetometer that detects a magnetic field generated by the wiring line coupled to the positive electrode or the negative electrode of the secondary battery Bd.

The sensor Se is a sensor that detects a physical quantity serving as a clue for detecting an internal short circuit in the secondary battery Be, and supplies a signal indicating the physical quantity to the controller 130. The sensor Se is, for example, an ammeter that detects a current flowing through a shunt resistor coupled in series to the secondary battery Be. The sensor Se may be configured to detect, for example, a physical quantity having a predetermined correlation with the current flowing through the shunt resistor described above. The sensor Se may be, for example, a voltmeter that detects a voltage of the shunt resistor described above, or a magnetometer that detects a magnetic field generated by the wiring line coupled to the positive electrode or the negative electrode of the secondary battery Be.

The sensor Sf is a sensor that detects a physical quantity serving as a clue for detecting an internal short circuit in the secondary battery Bf, and supplies a signal indicating the physical quantity to the controller 130. The sensor Sf is, for example, an ammeter that detects a current flowing through a shunt resistor coupled in series to the secondary battery Bf. The sensor Sf may be configured to detect, for example, a physical quantity having a predetermined correlation with the current flowing through the shunt resistor described above. The sensor Sf may be, for example, a voltmeter that detects a voltage of the shunt resistor described above, or a magnetometer that detects a magnetic field generated by the wiring line coupled to the positive electrode or the negative electrode of the secondary battery Bf.

Next, an operation of the power supply apparatus 100 according to an embodiment will be described.

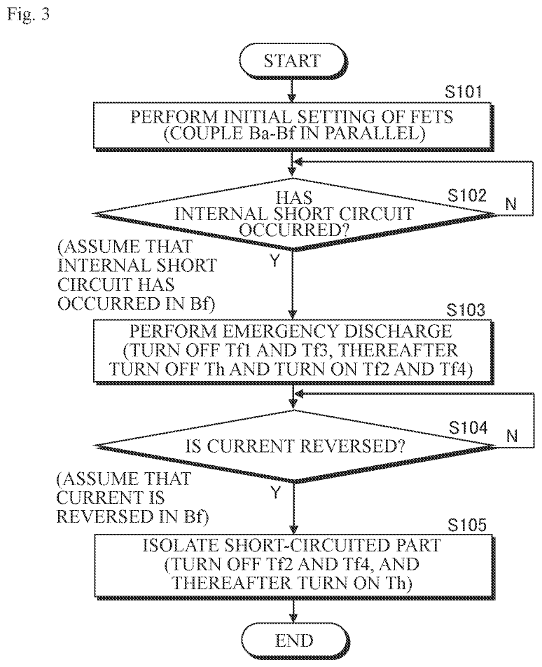

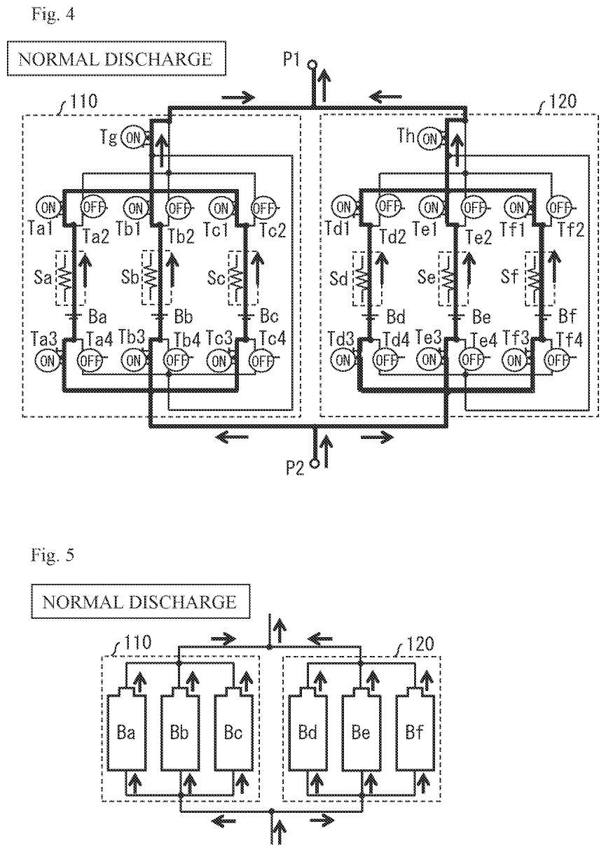

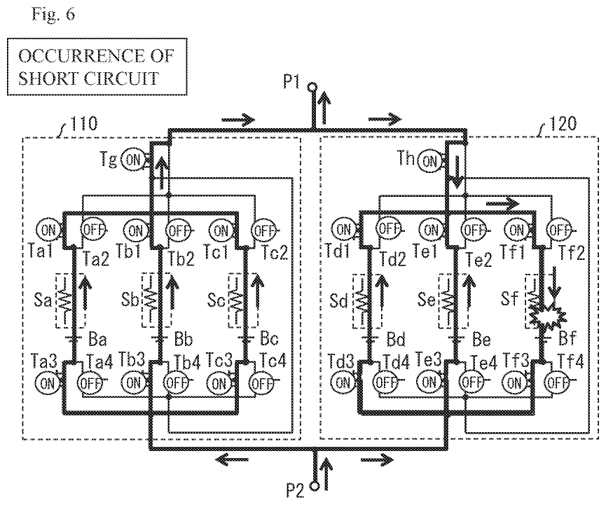

FIG. 3 illustrates an example of an emergency discharge procedure for the power supply apparatus 100. First, the controller 130 performs initial setting of each of the field-effect transistors (Ta1 to Th) (step S101). For example, as illustrated in FIGS. 4 and 5, the controller 130 so performs the initial setting of each of the field-effect transistors (Ta1 to Th) that the secondary batteries Ba to Bf are coupled in parallel to each other. The controller 130 turns on, for example, the field-effect transistors Ta1, Ta3, Tb1, Tb3, Tc1, Tc3, Td1, Td3, Te1, Te3, Tf1, Tf3, Tg, and Th. In addition, the controller 130 turns off, for example, the field-effect transistors Ta2, Ta4, Tb2, Tb4, Tc2, Tc4, Td2, Td4, Te2, Te4, Tf2, and Tf4.

After the above-described initial setting is completed, the controller 130 detects whether an internal short circuit has occurred in any of the secondary batteries Ba to Bf, using respective detection results obtained from the sensors Sa to Sf (step S102). For example, assume that a short circuit has occurred in the secondary battery Bf, as illustrated in FIG. 6, when the sensors Sa to Sf are current sensors. In this case, for example, a current outputted from each of the secondary batteries Ba to Be in which no short circuit has occurred flows into the secondary battery Bf in which the short circuit has occurred, as illustrated in FIG. 6. In this case, the sensor Sf detects the current flowing into the secondary battery Bf, and supplies the detection result to the controller 130.

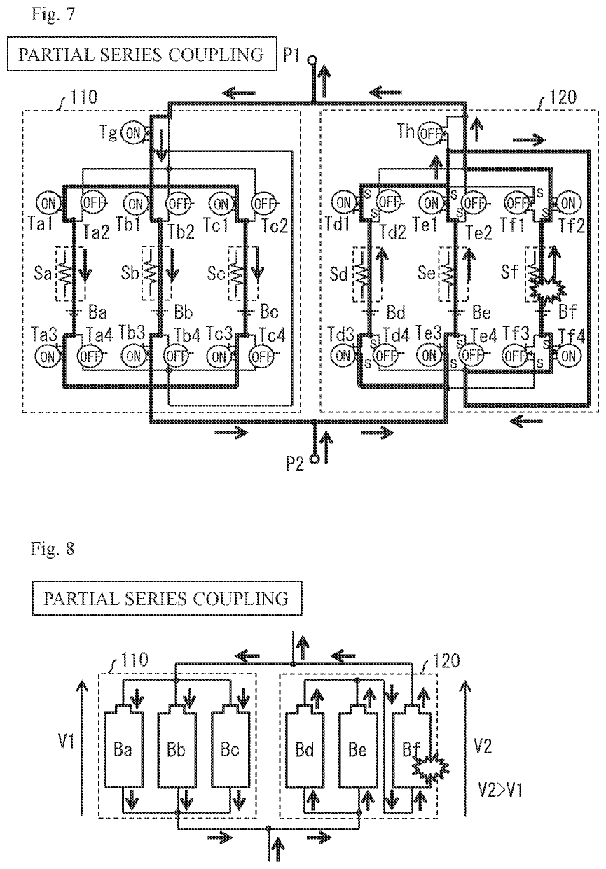

The controller 130 determines that a short circuit has occurred in the secondary battery Bf based on the detection result supplied from the sensor Sf (step S102; Y), and performs the emergency discharge (step S103). Upon the emergency discharge, the controller 130 switches coupling between the secondary battery Bf in which the short circuit has occurred and each of the secondary batteries Bd and Be in which no short circuit has occurred, from parallel coupling to series coupling, by controlling the field-effect transistors Ta1 to Th. For example, the controller 130 turns off the field-effect transistors Tf1 and Tf3, and thereafter turns off the field-effect transistor Th and turns on the field-effect transistors Tf2 and Tf4. As a result, for example, as illustrated in FIGS. 7 and 8, the secondary battery Bf in which the short circuit has occurred is coupled in series to each of the secondary batteries Bd and Be in which no short circuit has occurred, and the positive electrode of the secondary battery Bf is coupled to the positive electrode terminal P1 of the power supply apparatus 100.

In this case, when the secondary battery Bf is coupled in series to each of the secondary batteries Bd and Be, a voltage V2 of the secondary battery unit 120 as a whole is higher than a voltage V1 of the secondary battery unit 110 as a whole by an amount corresponding to a voltage of the secondary battery Bf. Accordingly, a current starts flowing from the secondary battery unit 120 into the secondary battery unit 110. That is, discharging of the secondary battery unit 120 is started, and charging of the secondary battery unit 110 is started. The discharging of the secondary battery unit 120 and the charging of the secondary battery unit 110 are continued until V2 becomes equal to V1. Thereafter, when V2 becomes lower than V1, a current starts flowing from the secondary battery unit 110 into the secondary battery unit 120. That is, a current flowing direction in the secondary battery unit 110 is reversed.

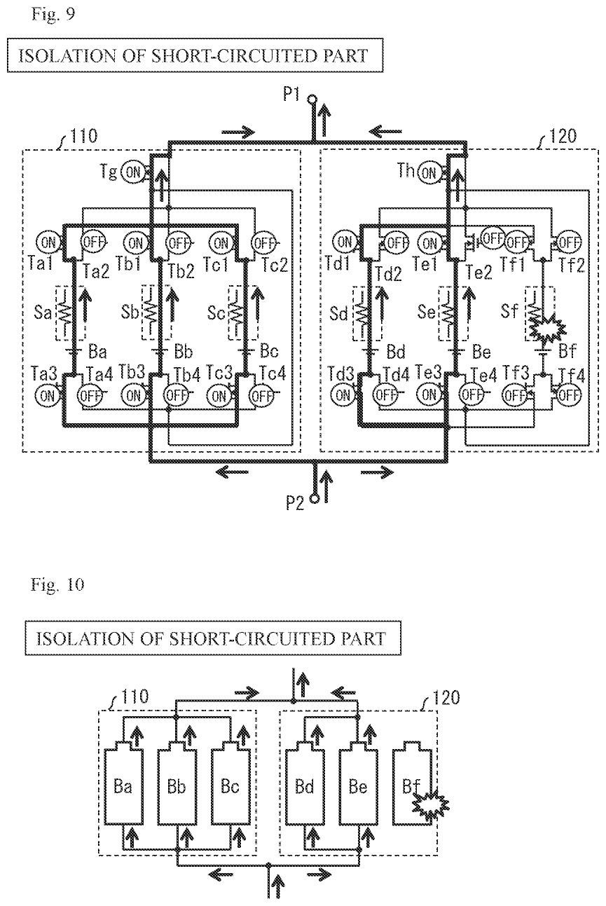

When the controller 130 determines that a direction of a current flowing through the secondary battery Bf in which the short circuit has occurred is reversed, based on the detection result supplied from the sensor Sf (step S104; Y), the controller 130 isolates a part where the short circuit has occurred (step S105). For example, the controller 130 turns off the field-effect transistors Tf2 and Tf4, and thereafter turns on the field-effect transistor Th to, for example, separate the secondary battery Bf in which the short circuit has occurred from a current path of each of the secondary batteries Bd and Be in which no short circuit has occurred, as illustrated in FIGS. 9 and 10.

Note that a timing of isolating the secondary battery Bf in which the short circuit has occurred is not limited to the timing when the direction of the current flowing through the secondary battery Bf in which the short circuit has occurred is reversed. For example, the controller 130 may isolate the part where the short circuit has occurred, when determining that the magnitude of the current flowing through the secondary battery Bf in which the short circuit has occurred is less than or equal to a predetermined threshold, based on the detection result supplied from the sensor Sf. For example, the controller 130 may isolate the part where the short circuit has occurred, when a predetermined time elapses since the partial serialization.

The emergency discharge in the power supply apparatus 100 is performed as described above. An operation of the emergency discharge is performed using the field-effect transistors Ta1 to Th. Therefore, it is unnecessary to use an MPPT circuit, and it is possible to perform the operation of the emergency discharge with a small device. In addition, it is possible to perform the emergency discharge without interrupting current supply from the power supply apparatus 100 to an external load. Therefore, there is no risk of losing the function of the power supply apparatus 100 even during the emergency discharge.

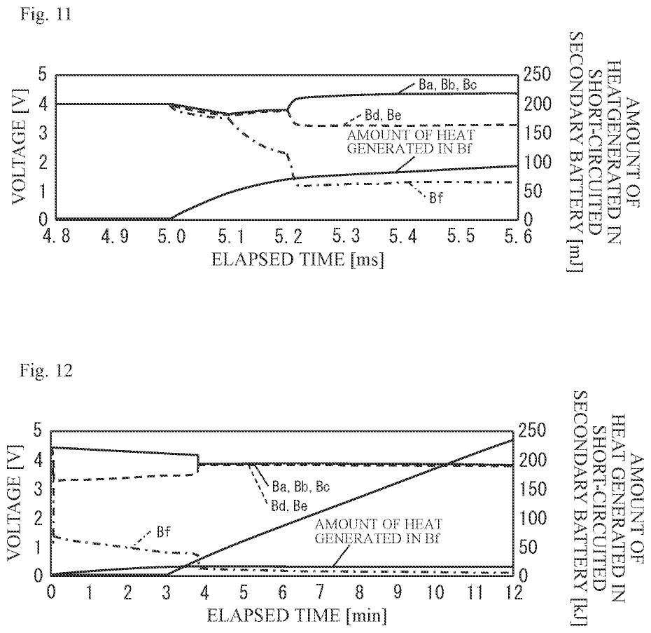

FIGS. 11 and 12 each illustrate an example of changes over time in the respective voltages of the secondary batteries Ba to Bf and in amount of heat generated in the secondary battery Bf in which the short circuit has occurred, when the short circuit has occurred in the power supply apparatus 100. The unit of a horizontal axis in FIG. 11 is milliseconds, and the unit of a horizontal axis in FIG. 12 is minutes. FIGS. 11 and 12 each present a result of examination on an effect of the power supply apparatus 100 performed by means of an electronic circuit simulator.

In the electronic circuit simulator, when describing each of the secondary batteries Ba to Bf, a capacitor (having an initial voltage of 4 V, an internal resistance of 30 mΩ, and a parasitic inductance of 10 nH) that had a capacitance of 4 kF was used instead of a voltage source. A reason for this is that a current is unlimitedly available from the voltage source and there is no concept of capacity in the voltage source. The capacitor having the capacitance of 4 kF was used to reproduce decreasing behavior of the voltage of each of the secondary batteries Ba to Bf caused by discharging. In the electronic circuit simulator, the total energy of the secondary batteries Ba to Bf was set to 32 kJ×6 =192 kJ, and a constant power load of 10 W was coupled to each of the secondary batteries Ba to Bf. That is, the load had been constantly suppled with power.

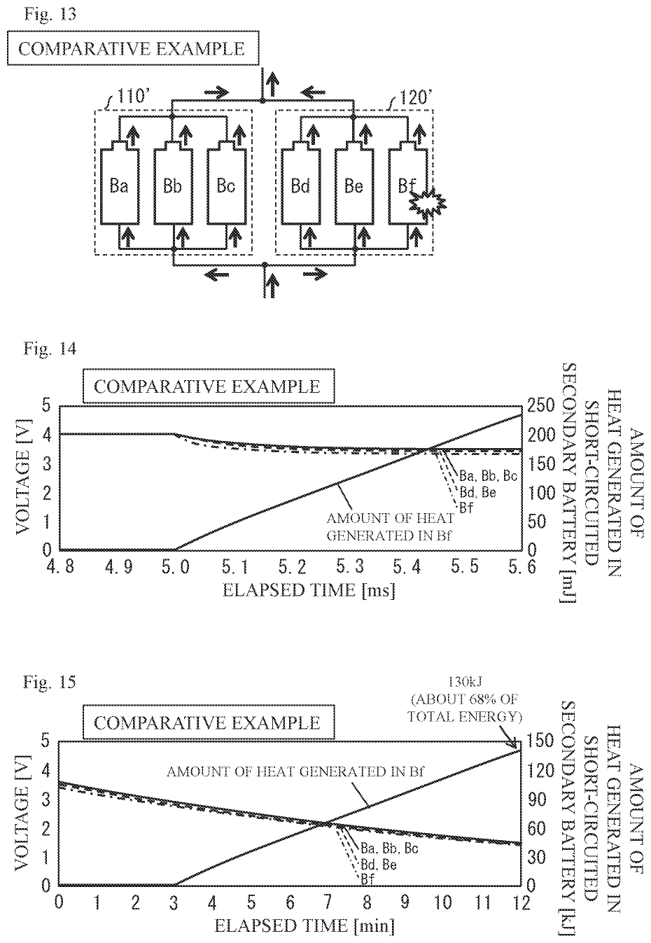

In the electronic circuit simulator, an internal short circuit was caused in the secondary battery Bf at a timing corresponding to an elapsed time of 5 ms. Specifically, an additional resistor was coupled in parallel to the secondary battery Bf, and a resistance value of the additional resistor was decreased from 1 MΩ to 30 mΩ at the timing corresponding to the elapsed time of 5 ms. Simulations were performed of a case where an amount of heat (in units of kJ) generated in the additional resistor was partially serialized (see FIG. 8) and of a case where the amount of heat generated in the additional resistor was not partially serialized (see FIG. 13). FIGS. 11 and 12 each present a result of the case where the partial serialization was performed. FIGS. 14 and 15 each present a result of the case where the partial serialization was not performed.

In the case where the partial serialization was not performed, the voltages of all of the secondary batteries Ba to Bf decreased from 5 ms, as illustrated in FIG. 14. A reason for this is that the energy of all of the secondary batteries Ba to Bf flowed into the secondary battery Bf in which the internal short circuit had occurred. As illustrated in FIG. 15, at a timing corresponding to an elapsed time of 12 minutes, energy of 130 kJ corresponding to about 68% of the total energy was converted into heat in the secondary battery Bf in which the internal short circuit had occurred.

In contrast, in the case where the partial serialization was performed, only the secondary battery Bf in which the internal short circuit had occurred was subjected to the emergency discharge, as illustrated in FIG. 11. The secondary battery Bf was sufficiently discharged, and thereafter, was isolated, as illustrated in FIG. 12. As a result of such a control, the amount of heat generated in the secondary battery Bf in which the internal short circuit had occurred became 7.2 kJ at the timing corresponding to the elapsed time of 12 minutes. This indicates that the amount of heat generated in the secondary battery Bf in which the internal short circuit had occurred was reduced by 94%, as compared with the case where the partial serialization was not performed. Note that, as illustrated in FIGS. 11 and 12, there was no interruption in the current flowing through each of the secondary batteries Ba to Be. This indicates that power was constantly supplied to the load.

Next, effects of the power supply apparatus 100 according to an embodiment will be described.

In an embodiment, it is possible to switch the coupling between the secondary battery Bf and each of the secondary batteries Bd and Be from the parallel coupling to the series coupling. Thus, for example, when an internal short circuit occurs in the secondary battery Bf, it is possible to cause a discharge current of the secondary battery unit 120 including the secondary battery Bf in which the internal short circuit has occurred to flow into the other secondary battery unit 110. As a result, it is possible to perform the emergency discharge of the secondary battery Bf in which the internal short circuit has occurred, without interrupting the power supply to the load.

In an embodiment, the sensors Sa to Sf are provided that each detect, for example, the current flowing through corresponding one of the secondary batteries Ba to Bf. It is possible to switch the coupling between the secondary battery Bf and each of the secondary batteries Bd and Be from the parallel coupling to the series coupling based on the detection result obtained from each of the sensors Sa to Sf. This makes it possible to, for example, when an internal short circuit occurs in the secondary battery Bf, cause the discharge current of the secondary battery unit 120 including the secondary battery Bf in which the internal short circuit has occurred to flow into the other secondary battery unit 110. As a result, it is possible to perform the emergency discharge of the secondary battery Bf in which the internal short circuit has occurred, without interrupting the power supply to the load.

In an embodiment, after the emergency discharge is performed, the secondary battery Bf in which the internal short circuit has occurred is separated from the current path of each of the secondary batteries Bd and Be in which no internal short circuit has occurred. This eliminates the risk of charging the secondary battery Bf in which the internal short circuit has occurred, therefore making it possible to prevent occurrence of thermal runaway in the secondary battery Bf.

In an embodiment, the coupling between the secondary battery Bf and each of the secondary batteries Bd and Be is achieved by the field-effect transistors Ta1 to Th. This makes the MPPT circuit unnecessary in performing the emergency discharge. It is therefore possible to reduce the size of the power supply apparatus 100.

Next, a circuit configuration of each of the sensors Sa to Sf will be described. The sensors Sa to Sf have a common circuit configuration. Therefore, in the following, the circuit configuration of the sensor Sa representing the sensors Sa to Sf will be described. Note that a device including the sensors Sa to Sf and the controller 130 corresponds to a specific example of a “power supply control apparatus” of the technology.

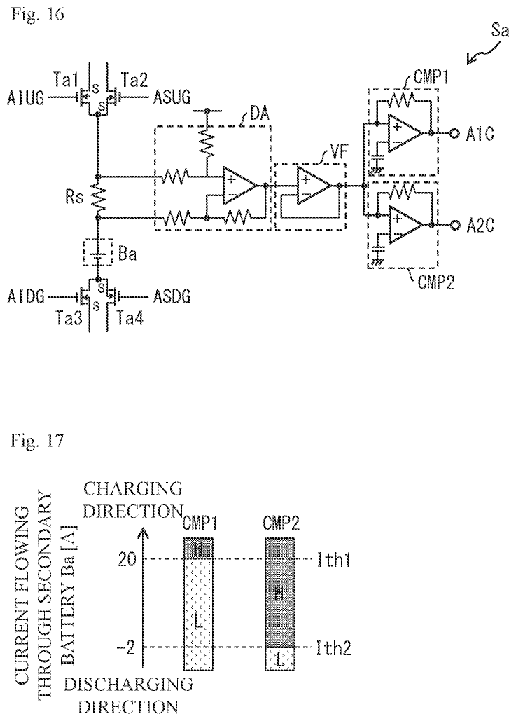

FIG. 16 illustrates an example of the circuit configuration of the sensor Sa. The sensor Sa detects a current flowing through the current path of the secondary battery Ba, and outputs data regarding a relationship between a detection result and two thresholds. As illustrated in FIG. 16, the sensor Sa includes, for example, a shunt resistor Rs provided in the current path of the secondary battery Ba, an operating amplifier circuit DA, a voltage follower VF, and comparators CMP1 and CMP2.

The shunt resistor Rs is coupled in series to the secondary battery Ba. The shunt resistor Rs is disposed, for example, on the positive electrode side of the secondary battery Ba in the current path of the secondary battery Ba. Note that the shunt resistor Rs may be disposed, for example, on the negative electrode side of the secondary battery Ba in the current path of the secondary battery Ba.

The operating amplifier circuit DA includes, for example, an operational amplifier and multiple resistors, and outputs a voltage corresponding to a difference between voltages at both ends of the shunt resistor Rs. The voltage follower VF includes, for example, a non-inverting amplifier circuit, and outputs the voltage supplied from the operating amplifier circuit DA to the comparators CMP1 and CMP2 as it is.

The comparator CMP1 is a comparator adapted to detect an internal short circuit. The comparator CMP1 outputs, as a signal A1C, a result of comparison between a reference voltage (a reference value) and the voltage supplied from the voltage follower VF. Here, the reference voltage (the reference value) is a value corresponding to a current flowing in a direction of charging of the secondary battery. As illustrated in FIG. 17, the reference voltage (the reference value) corresponds to, for example, a voltage to be supplied from the voltage follower VF to the comparator CMP1 when a current of a current value Ith1 (e.g., 20 A) flows through the shunt resistor Rs. The current value Ith1 is slightly smaller than a value of a current that flows through the current path of the secondary battery Ba when an internal short circuit occurs in the secondary battery Ba.

The comparator CMP2 is a comparator adapted to detect a lateral current. The “lateral current” refers to a current flowing from one secondary battery to another secondary battery where the two secondary batteries are coupled in parallel to each other. As illustrated in FIG. 6, the “lateral current” refers to, for example, when an internal short circuit occurs in the secondary battery Bf, a current flowing, into the secondary battery Bf in which the internal short circuit has occurred, from other secondary batteries (i.e. the secondary batteries Ba, Bb, Bc, Bd, and Be) in parallel to the secondary battery Bf.

The comparator CMP2 outputs, as a signal A2C, a result of comparison between a reference voltage (a reference value) and the voltage supplied from the voltage follower VF. Here, the reference voltage (the reference value) is a value corresponding to a current flowing in a direction of discharging of the secondary battery. As illustrated in FIG. 17, the reference voltage (the reference value) corresponds to, for example, a voltage to be supplied from the voltage follower VF to the comparator CMP2 when a current of a current value Ith2 (e.g., −2 A) flows through the shunt resistor Rs. The current value Ith2 is slightly smaller than a current value of the “lateral current” that flows through the current path of the secondary battery Ba.

The controller 130 determines that an internal short circuit has occurred in the secondary battery Bf, for example, when: an output of the comparator CMP1 assigned to the secondary battery Bf, which is one of the secondary batteries Ba to Bf included in the secondary battery units 110 and 120, indicates a charging side relative to the reference voltage (the reference value); and an output of the comparator CMP2 assigned to each of the secondary batteries Ba to Be, other than the secondary battery Bf, of the secondar batteries Ba to Bf included in the secondary battery units 110 and 120 indicates a discharging side relative to the reference voltage (the reference value).

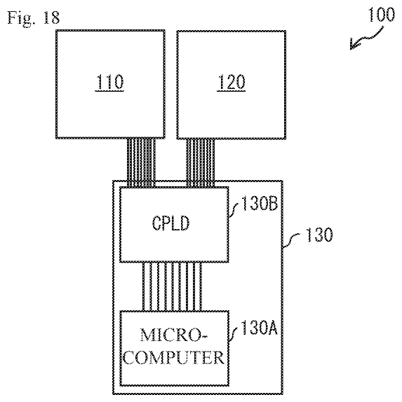

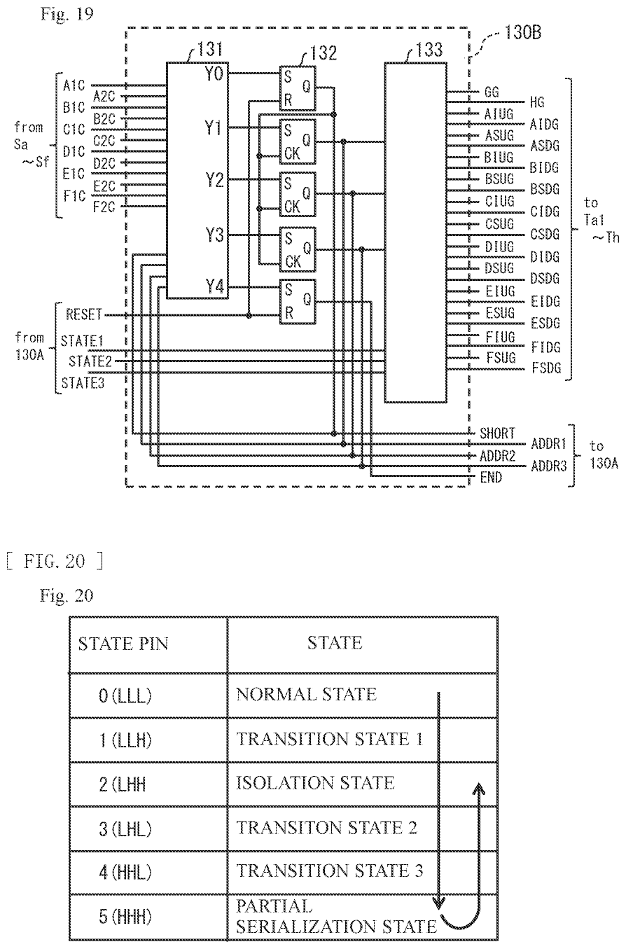

FIG. 18 illustrates an example of a circuit configuration of the controller 130. As illustrated in FIG. 18, the controller 130 includes, for example, a microcomputer 130A in chip form and a complex programmable logic device (CPLD) 130B in chip form. FIG. 19 illustrates an example of a circuit configuration of the CPLD 130B.

The microcomputer 130A generates information regarding a state of the secondary battery units 110 and 120 based on information regarding an internal short circuit in each of the secondary batteries Ba to Bf obtained from the CPLD 130B, and outputs the generated information to the CPLD 130B. Here, the “information regarding the internal short circuit in each of the secondary batteries Ba to Bf” includes, for example, SHORT, ADDR1, ADDR2, ADDR3, and END, which will be described later. The “information regarding the state of the secondary battery units 110 and 120” includes, for example, STATE1, STATE2, and STATE3, which will be described later.

SHORT goes high when an internal short circuit is detected in any of the secondary batteries Ba to Bf, and goes low when an internal short circuit is detected in none of the secondary batteries Ba to Bf. That is, the CPLD 130B detects an internal short circuit based on the detection results of all of the sensors Sa to Sf, and outputs SHORT corresponding to the detection results. The CPLD 130B detects an internal short circuit based on, for example, values of currents flowing through all of the secondary batteries Ba to Bf.

ADDR1, ADDR2, and ADDR3 serve as an identifier of the secondary battery in which an internal short circuit is detected. As illustrated in FIG. 20, STATE1, STATE2, and STATE3 indicate, for example, a state of the secondary battery unit (the secondary battery unit 120) in which the internal short circuit is detected. END goes high when a “lateral current” is detected in a direction in which a current flows into the secondary battery unit in which the internal short circuit is detected, and constantly remains high.

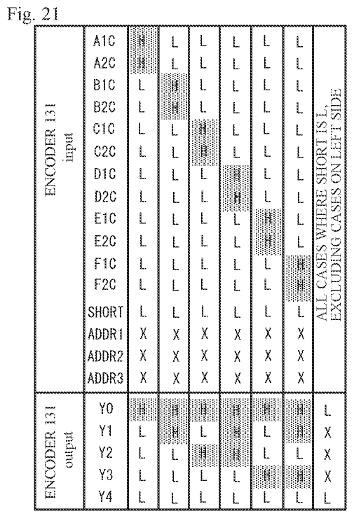

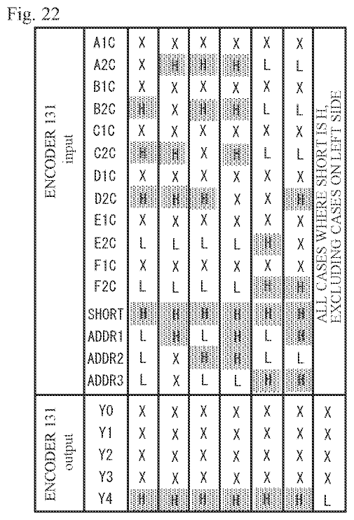

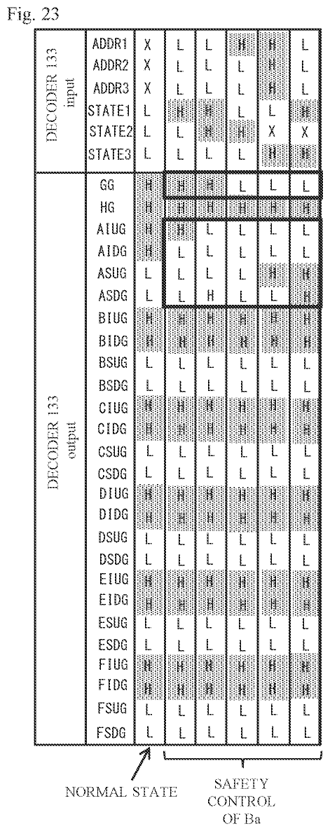

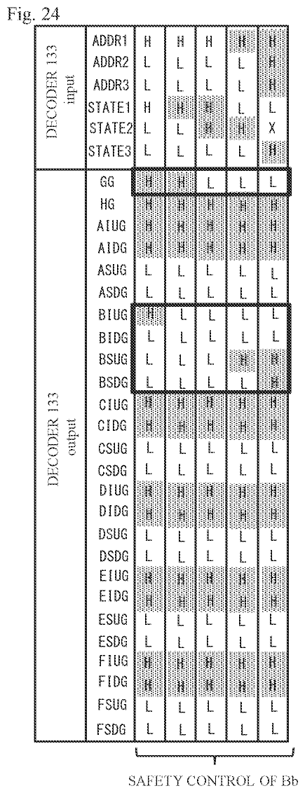

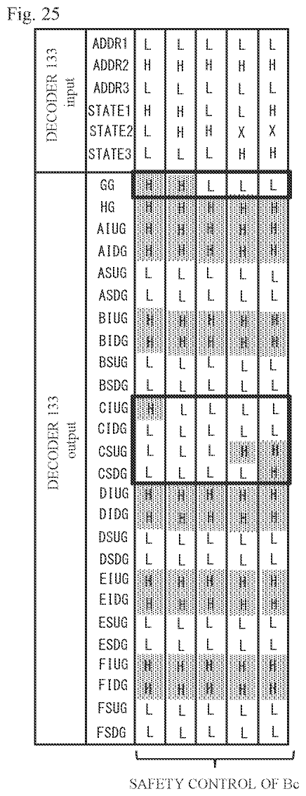

The CPLD 130B is a logic IC circuit, and is a circuit in which truth tables illustrated in FIGS. 21 and 22 to be described later are incorporated. The CPLD 130B generates information regarding the internal short circuits in the respective secondary batteries Ba to Bf based on the respective detection results obtained from the sensors Sa to Sf, and outputs the generated information to the microcomputer 130A. The detection results obtained from the sensors Sa to Sf include, for example, A1C, A2C, B1C, B2C, C1C, C2C, D1C, D2C, E1C, E2C, F1C, and F2C. A1C and A2C are the detection results obtained from the sensor Sa. B1C and B2C are the detection results obtained from the sensor Sb. C1C and C2C are the detection results obtained from the sensor Sc. D1C and D2C are the detection results obtained from the sensor Sd. E1C and E2C are the detection results obtained from the sensor Se. F1C and F2C are the detection results obtained from the sensor Sf.

The CPLD 130B further generates signals (control signals) adapted to control the field-effect transistors Ta1 to Th based on the detection results obtained from the sensors Sa to Sf, and outputs the generated signals to respective gates of the field-effect transistors Ta1 to Th. The signals (control signals) adapted to control the field-effect transistors Ta1 to Th include, for example, AIUG, AIDG, ASUG, ASDG, BIUG, BIDG, BSUG, BSDG, CIUG, CIDG, CSUG, CSDG, DIUG, DIDG, DSUG, DSDG, EIUG, EIDG, ESUG, ESDG, FIUG, FIDG, FSUG, FSDG, GG, and HG.

AIUG, AIDG, ASUG, and ASDG are supplied to the respective gates of the field-effect transistors Ta1 to Ta4. AIUG, AIDG, ASUG, and ASDG are supplied to the respective gates of the field-effect transistors Ta1 to Ta4. BIUG, BIDG, BSUG, and BSDG are supplied to the respective gates of the field-effect transistors Tb1 to Tb4. CIUG, CIDG, CSUG, and CSDG are supplied to the respective gates of the field-effect transistors Tc1 to Tc4. DIUG, DIDG, DSUG, and DSDG are supplied to the respective gates of the field-effect transistors Td1 to Td4. EIUG, EIDG, ESUG, and ESDG are supplied to the respective gates of the field-effect transistors Te1 to Te4. FIUG, FIDG, FSUG, and FSDG are supplied to the respective gates of the field-effect transistors Tf1 to Tf4. GG is supplied to the gate of the field-effect transistor Tg. HG is supplied to the gate of the field-effect transistor Th.

As illustrated in FIG. 19, the CPLD 130B includes, for example, an encoder 131, multiple latches 132, and a decoder 133.

The encoder 131 generates pieces of information (Y0, Y1, Y2, Y3, and Y4) regarding the internal short circuit in each of the secondary batteries Ba to Bf based on, for example, the detection results obtained from the sensors Sa to Sf and the outputs from the latches 132, and outputs the generated pieces of information to the latches 132. The latches 132 each hold the information supplied from the encoder 131. The outputs from the latches 132 are supplied to, for example, the encoder 131 and the decoder 133 as pieces of information (SHORT, ADDR1, ADDR2, and ADDR3) regarding the internal short circuit in each of the secondary batteries Ba to Bf. The outputs from the latches 132 are also supplied to the microcomputer 130A as pieces of information (SHORT, ADDR1, ADDR2, ADDR3, and END) regarding the internal short circuit in each of the secondary batteries Ba to Bf.

The decoder 133 generates signals (control signals) adapted to control the field-effect transistors Ta1 to Th, based on the pieces of information regarding the internal short circuit in each of the secondary batteries Ba to Bf supplied from the latches 132 and the pieces of information regarding the state of the secondary battery units 110 and 120 supplied from the microcomputer 130A. The decoder 133 supplies the generated control signals to the respective gates of the field-effect transistors Ta1 to Th.

FIGS. 21 and 22 each illustrate an example of input and output combinations (a truth table) of the encoder 131. FIG. 21 illustrates a truth table of a case where an internal short circuit is detected. FIG. 22 illustrates a truth table of a case where emergency discharge of a secondary battery in which an internal short circuit has occurred is completed. “Completion of emergency discharge” refers to a timing of detection of a “lateral current” in a direction in which a current flows into a secondary battery unit in which an internal short circuit is detected.

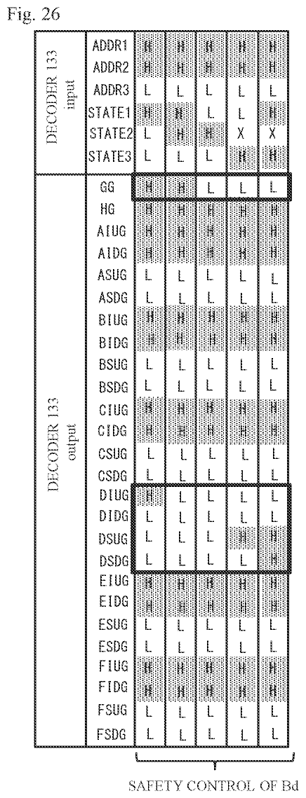

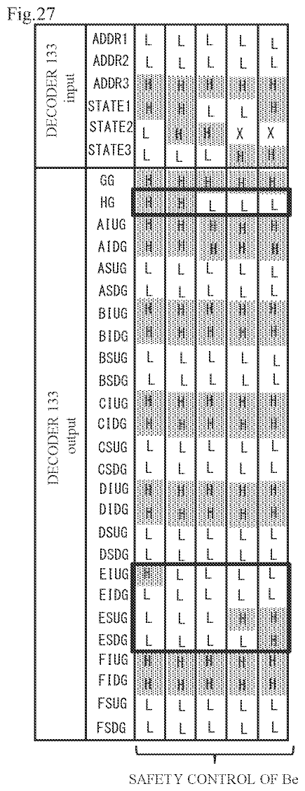

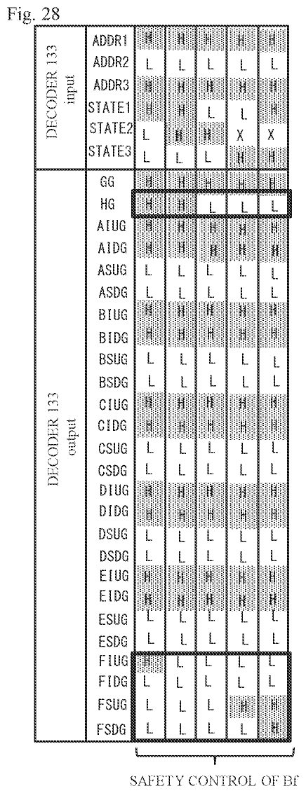

FIGS. 23, 24, 25, 26, 27, and 28 each illustrate an example of input and output combinations (a truth table) of the decoder 133. FIG. 23 illustrates a truth table for a normal state and a change in the truth table from a timing when an internal short circuit is detected in the secondary battery Ba to a timing when a “lateral current” is detected in a direction of a current flowing into the secondary battery unit 110 including the secondary battery Ba in which the internal short circuit is detected. FIG. 24 illustrates a change in truth table from a timing when an internal short circuit is detected in the secondary battery Bb to a timing when a “lateral current” is detected in a direction of a current flowing into the secondary battery unit 110 including the secondary battery Bb in which the internal short circuit is detected. FIG. 25 illustrates a change in truth table from a timing when an internal short circuit is detected in the secondary battery Bc to a timing when a “lateral current” is detected in a direction of a current flowing into the secondary battery unit 110 including the secondary battery Bc in which the internal short circuit is detected. FIG. 26 illustrates a change in truth table from a timing when an internal short circuit is detected in the secondary battery Bd to a timing when a “lateral current” is detected in a direction of a current flowing into the secondary battery unit 120 including the secondary battery Bd in which the internal short circuit is detected. FIG. 27 illustrates a change in truth table from a timing when an internal short circuit is detected in the secondary battery Be to a timing when a “lateral current” is detected in a direction of a current flowing into the secondary battery unit 120 including the secondary battery Be in which the internal short circuit is detected. FIG. 28 illustrates a change in truth table from a timing when an internal short circuit is detected in the secondary battery Bf to a timing when a “lateral current” is detected in a direction of a current flowing into the secondary battery unit 120 including the secondary battery Bf in which the internal short circuit is detected.

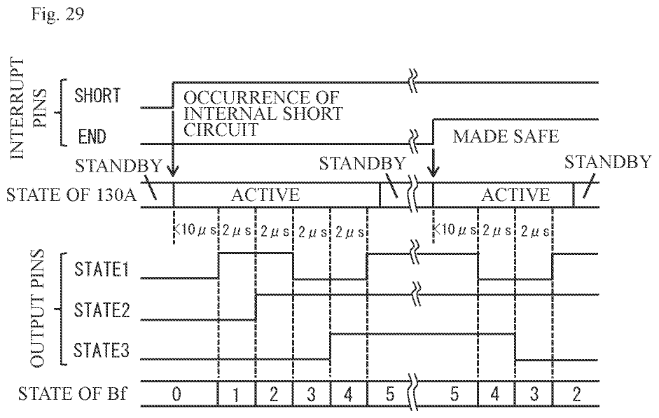

Note that parts surrounded by thick frames in FIGS. 23 to 28 indicate procedures for controlling the four field-effect transistors coupled to the secondary battery in which the internal short circuit has occurred and the field-effect transistor common to the secondary batteries in the secondary battery unit including the secondary battery in which the internal short circuit has occurred, and the control procedures are the same as each other. Therefore, in the following, a procedure for controlling the five field-effect transistors Tf1, Tf2, Tf3, Tf4, and Th will be described below, with reference to FIG. 29.

FIG. 29 illustrates an example of the procedure for controlling the five field-effect transistors Tf1, Tf2, Tf3, Tf4, and Th when an internal short circuit has occurred in the secondary battery Bf. A state of the secondary battery Bf is presented at the bottom of FIG. 29. The numbers indicating the state of the secondary battery Bf presented at the bottom of FIG. 29 corresponds to the numbers in a STATE pin column in FIG. 20.

The encoder 131 detects the internal short circuit in the secondary battery Bf. Upon the detection, the encoder 131 causes SHORT to transition from low to high. In addition, the encoder 131 outputs an identifier indicating the secondary battery Bf as addresses (ADDR1, ADDR2, and ADDR3). When detecting the transition of SHORT from low to high, the microcomputer 130A starts, and causes STATE1 to transition to high at a predetermined timing. Based on the addresses supplied via the latches 132 and the state “1” supplied from the microcomputer 130A, the decoder 133 supplies respective control signals corresponding to the state “1” to the five field-effect transistors Tf1, Tf2, Tf3, Tf4, and Th.

Thereafter, the microcomputer 130A causes STATE2 to transition to high at a predetermined timing. The decoder 133 supplies respective control signals corresponding to the state “2” to the five field-effect transistors Tf1, Tf2, Tf3, Tf4, and Th based on the addresses supplied via the latches 132 and the state “2” supplied from the microcomputer 130A. Thereafter, the microcomputer 130A sequentially switches the state in order of “3”, “4”, “5”, “4”, “3”, and “2”, to cause the decoder 133 to sequentially supply respective control signals corresponding to the state to the five field-effect transistors Tf1, Tf2, Tf3, Tf4, and Th. In this manner, the secondary battery Bf in which the internal short circuit has occurred is subjected to the emergency discharge and is isolated.

Next, a description will be given of effects of the device including the sensors Sa to Sf, each including the circuit illustrated in FIG. 16, and the controller 130, and effects of the power supply apparatus 100 including such a device.

In the embodiment, the current flowing through the current path of each of the secondary batteries Ba to Bf is detected by corresponding one of the sensors Sa to Sf, and a secondary battery in which an internal short circuit has occurred is detected based on the respective detection results obtained from the sensors Sa to Sf. This makes it possible to reduce erroneous detection caused by noise included in a sensor output, as compared with a case where an internal short circuit is detected by each sensor. As a result, it is possible to accurately detect an internal short circuit in each of the secondary batteries Ba to Bf.

In an embodiment, the two comparators CMP1 and CMP2 are provided in each of the sensors Sa to Sf. Thus, when an internal short circuit occurs in one secondary battery, the comparator CMP1 detects a current flowing from a secondary battery in which no internal short circuit has occurred toward the secondary battery in which the internal short circuit has occurred, and the comparator CMP2 detects a current flowing into the secondary battery in which the internal short circuit has occurred.

As a result, it is possible to reduce erroneous detection caused by noise included in a sensor output, as compared with the case where an internal short circuit is detected by each sensor. It is therefore possible to accurately detect an internal short circuit in each of the secondary batteries Ba to Bf.

In an embodiment, it is determined that an internal short circuit has occurred in the secondary battery Bf when: the output of the comparator CMP1 assigned to the secondary battery Bf, which is one of the secondary batteries Ba to Bf included in the secondary battery units 110 and 120, indicates the charging side relative to the reference value of the comparator CMP1; and the output of the comparator CMP2 assigned to each of the secondary batteries Ba to Be, other than the secondary battery Bf, of the secondary batteries Ba to Bf included in the secondary battery units 110 and 120 indicates the discharging side relative to the reference value of the comparator CMP2. This makes it possible to reduce erroneous detection caused by noise included in a sensor output, as compared with the case where an internal short circuit is detected by each sensor. As a result, it is possible to accurately detect an internal short circuit in each of the secondary batteries Ba to Bf.

The effects described herein are mere examples, and effects of the present technology are therefore not limited thereto. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A power supply control apparatus comprising:
a controller that controls discharging of secondary battery units, the secondary battery units each including secondary batteries and a switching unit, and being coupled in parallel to each other, the switching unit switching coupling of the secondary batteries; and
sensors assigned to the secondary batteries on a one-to-one basis, the sensors each detecting a current flowing through a current path of corresponding one of the secondary batteries or a physical quantity having a predetermined correlation with the current, wherein
the controller switches coupling between a first secondary battery and each of one or more second secondary batteries from parallel coupling to series coupling by controlling the switching unit based on a detection result obtained from each of the sensors, the first secondary battery being any one of the secondary batteries, the one or more second secondary batteries being one or more of the secondary batteries other than the first secondary battery.

2. The power supply control apparatus according to claim 1, wherein
the sensors each include a first comparator and a second comparator,
the first comparator has a first reference value corresponding to a current flowing in a direction of charging of corresponding one of the secondary batteries to which the first comparator is assigned, and
the second comparator has a second reference value corresponding to a current flowing in a direction of discharging of the corresponding one of the secondary batteries to which the second comparator is assigned.

3. The power supply control apparatus according to claim 2, wherein the controller determines that an internal short circuit has occurred in the first secondary battery and executes switching from the parallel coupling to the series coupling when an output of the first comparator assigned to the first secondary battery indicates a charging side relative to the first reference value and an output of the second comparator assigned to each of two or more second secondary batteries indicates a discharging side relative to the second reference value, the first secondary battery being one of the secondary batteries included in the secondary battery units, the two or more second secondary batteries being two or more of the secondary batteries included in the secondary battery units other than the first secondary battery.

4. The power supply control apparatus according to claim 1, wherein, by controlling the switching unit, the controller switches the coupling between the first secondary battery and each of the one or more second secondary batteries from the parallel coupling to the series coupling, and thereafter separates the first secondary battery from a current path of each of the one or more second secondary batteries.

5. The power supply control apparatus according to claim 3, wherein, when determining that a direction of a current flowing through the first secondary battery is reversed, based on the detection result obtained from corresponding one of the sensors, the controller separates the first secondary battery from a current path of each of the one or more second secondary batteries by controlling the switching unit.

6. The power supply control apparatus according to claim 1, wherein the switching unit includes multiple transistors.

7. A power supply apparatus comprising:
secondary battery units coupled in parallel to each other; and
a controller that controls discharging of the secondary battery units, wherein
the secondary battery units each include
secondary batteries,
a switching unit that switches coupling of the secondary batteries, and
sensors assigned to the secondary batteries on a one-to-one basis, the sensors each detecting a current flowing through a current path of corresponding one of the secondary batteries or a physical quantity having a predetermined correlation with the current, and
the controller switches coupling between a first secondary battery and each of one or more second secondary batteries from parallel coupling to series coupling by controlling the switching unit based on a detection result obtained from each of the sensors, the first secondary battery being any one of the secondary batteries, the one or more second secondary batteries being one or more of the secondary batteries other than the first secondary battery.
